(19) United States
(12) Patent Application Publication
(10) Pub. No.: US 2015/0086858 A1
(43) Pub. Date: Mar. 26, 2015

(54) RECHARGEABLE BATTERY

(71) Applicant: Samsung SDI Co., Ltd., Yongin-si (KR)

(72) Inventors: Jae-Il Seong, Yongin-si (KR); Hideaki Yoshio, Yongin-si (KR); Ji-Won Yun, Yongin-si (KR)

(73) Assignee: Samsung SDI Co., Ltd., Yongin-si (KR)

(21) Appl. No.: 14/191,779

(22) Filed: Feb. 27, 2014

Related U.S. Application Data
(60) Provisional application No. 61/881,826, filed on Sep. 24, 2013.

(51) Int. Cl. H01M 2/02

(52) U.S. Cl. CPC H01M 2/0277
USPC 429/179; 205/316; 29/623.2

(57) ABSTRACT

A rechargeable battery includes: an electrode assembly; an outer case to enclose the electrode assembly, where the outer case includes an opening; a cap plate to seal the opening of the outer case; an insulating case of a predetermined height installed within the outer case, the insulating case installed between the cap plate and the electrode assembly; and an electrode terminal installed on the cap plate and electrically connected to the electrode assembly, where the outer case includes an insulating portion formed on an inner surface of the opening thereof adjacent said insulating case, said insulating portion being electrically insulating, and said insulating portion located at an upper portion of the outer case and being shaped to prevent foreign substances from flowing from the external environment into the outer case.

### CROSS-REFERENCE TO RELATED APPLICATIONS

This application claims the benefit of U.S. Provisional Patent Application No. 61/881,826, filed on Sep. 24, 2013, in the United States Patent and Trademark Office, the disclosure of which is incorporated herein in its entirety by reference. Any and all priority claims identified in the Application Data Sheet, or any correction thereto, are hereby incorporated by reference under 37 CFR 1.57.

### BACKGROUND

1. Field

The present disclosure relates to a rechargeable battery having an insulating case interposed between an electrode assembly inserted into an outer case and a cap plate.

2. Description of the Related Technology

A rechargeable battery performs repetitive charging and discharging, unlike the primary battery. A small-capacity rechargeable battery is used in small-sized portable electronic devices, such as a mobile phone, a laptop, and a camcorder, and a large-capacity battery is used as a power source for motor drive, such as an electric bicycle, a scooter, an electric vehicle, a fork lift, and the like.

The rechargeable battery includes an electrode assembly in which a positive electrode and a negative electrode are laminated with a separator therebetween and then wound in a jelly roll type, an outer case containing the electrode assembly together with an electrolyte therein, a cap plate sealing an opening formed in an upper end of the outer case, an electrode terminal installed on the cap plate and electrically connected to the electrode assembly, and an insulating case installed between the electrode assembly and the cap plate.

During assembly of the rechargeable battery, in the processes of inserting the electrode assembly into the outer case, inserting the insulating case into the outer case, and inserting the cap plate into the opening of the outer case, metal foreign substances (e.g., residual foreign substances of parts and external substances) may flow into the opening of the outer case.

After the electrode assembly is inserted into the outer case, the metal foreign substances flowing into the opening of the outer case may cause an electric circuit between the outer case and the electrode assembly in the opening of the outer case. Therefore, safety of the rechargeable battery may be deteriorated.

The above information disclosed in this Background section is only for enhancement of understanding of the background of the described technology and therefore it may contain information that does not form the prior art that is already known in this country to a person of ordinary skill in the art.

### SUMMARY OF CERTAIN INVENTIVE ASPECTS

The described technology has been made in an effort to provide a rechargeable battery having an advantage of improving safety thereof by preventing an outer case and an electrode assembly from short-circuiting due to metal foreign substances in an opening of the outer case, after the electrode assembly is inserted into the outer case.

One embodiment provides a rechargeable battery including: an electrode assembly; an outer case configured to enclose the electrode assembly, wherein the outer case includes an opening; a cap plate configured to seal the opening of the outer case; an insulating case of a predetermined height installed within the outer case, the insulating case installed between the cap plate and the electrode assembly; and an electrode terminal installed on the cap plate and electrically connected to the electrode assembly, wherein the outer case includes an insulating portion formed on an inner surface of the opening thereof adjacent said insulating case, said insulating portion being electrically insulating, and said insulating portion located at an upper portion of the outer case and being shaped to prevent foreign substances from flowing from the external environment into the outer case.

The rechargeable battery may further include an electrolyte, wherein the outer case is configured to enclose the electrolyte; and the insulating portion is insoluble in the electrolyte.

The insulating case may be formed with a step difference from the opening of the outer case.

The insulating portion may have a first height between the opening and the electrode assembly, where the first height may be larger than the predetermined height of the insulating case.

A lower surface of the insulating portion may be closer to the electrode assembly than a lower surface of the insulating case.

The insulating portion may include at least one of polyimide, epoxy, or polypropylene.

The insulating portion may have a uniform thickness along its height.

The insulating portion may have an inclined structure along it height, wherein the insulating portion is gradually thickened in a direction from the opening of the electrode assembly.

The insulating portion may have a concave-convex structure along its height.

The outer case may include two flat surface portions and two curved portions surrounding the flat surface portions, and wherein the insulating portion has a maximum thickness in a direction between the outer case and the insulating case.

The insulating portion may include a plurality of grooves and protrusions alternately arranged between the insulating case and the outer case.

The insulating portion may surround the insulating case.

The thickness of the insulating portion may be from about 8 to about 20 micrometers.

According to one embodiment, a method of producing a rechargeable battery, includes: providing an electrode assembly; forming an insulating portion on an upper portion of an inner surface of an outer case, wherein the outer case includes an opening above the upper portion; enclosing the electrode assembly in the outer case; installing an insulating case of a predetermined height within the outer case, whereby the insulating case is adjacent the insulating portion; sealing the opening of the case with the cap plate, whereby the insulating case is between the cap plate and the electrode assembly; installing an electrode terminal on the cap plate, said electrode terminal being electrically connected to the electrode assembly.

Forming the insulating portion may include spray coating using an ink jet nozzle.

Forming the insulating portion may include electro-deposition coating.

The method of producing the rechargeable battery may further include injecting an electrolyte through an electrolyte injection port in the cap plate.

The thickness of the insulating portion formed may be from about 8 to about 20 micrometers.

According to some embodiments, the insulating portion is formed on an inner surface of the case, corresponding to a space between the cap plate and the electrode assembly, so that the case and the electrode assembly can be prevented from short circuiting therebetween due to metal foreign substances in the opening of the case, after the insertion of the electrode assembly into the case. Safety of the rechargeable battery can thus be improved.

### BRIEF DESCRIPTION OF THE DRAWINGS

FIG. 1 is an exploded perspective view of a rechargeable battery according to one embodiment;

FIG. 2 is a cross-sectional view taken along line II-II in FIG. 1;

FIG. 3 is a cross-sectional view of a case taken along line II-II in FIG. 1;

FIG. 4 is a cross-sectional view of a case taken along line IV-IV in FIG. 1;

FIG. 5 is a partial cross-sectional view of a case used in a rechargeable battery according to one embodiment;

FIG. 6 is a partial cross-sectional view of a case used in a rechargeable battery according to one embodiment;

FIG. 7 is a plane view of a case used in a rechargeable battery according to one embodiment;

FIG. 8 is a partial cross-sectional view of a case used in a rechargeable battery according to one embodiment; and

FIG. 9 is a plane view of FIG. 8.

### DETAILED DESCRIPTION OF CERTAIN INVENTIVE EMBODIMENTS

Hereinafter, the present invention will be described more fully hereinafter with reference to the accompanying drawings, in which certain embodiments of the invention are shown. As those skilled in the art would realize, the described embodiments may be modified in various ways, without departing from the spirit or scope of the present invention. The drawings and description are to be regarded as illustrative in nature and not restrictive. Like reference numerals generally designate like elements throughout the specification.

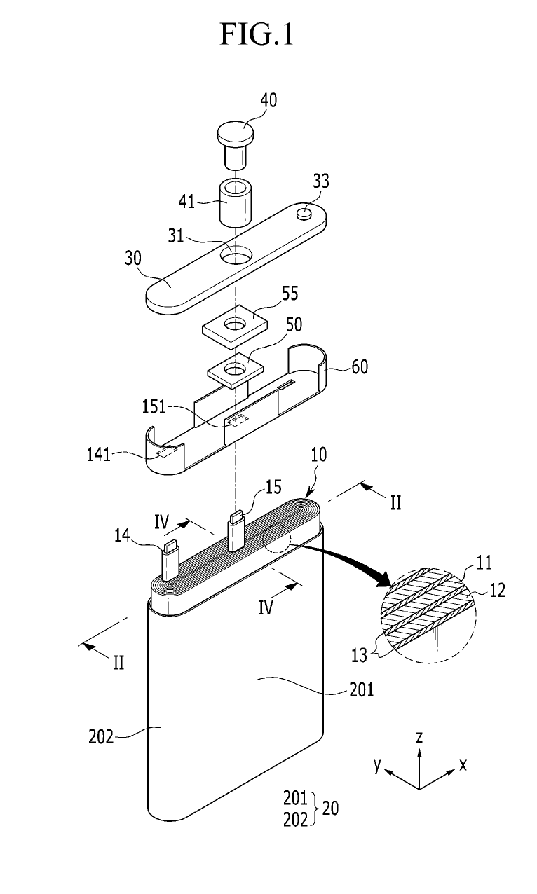

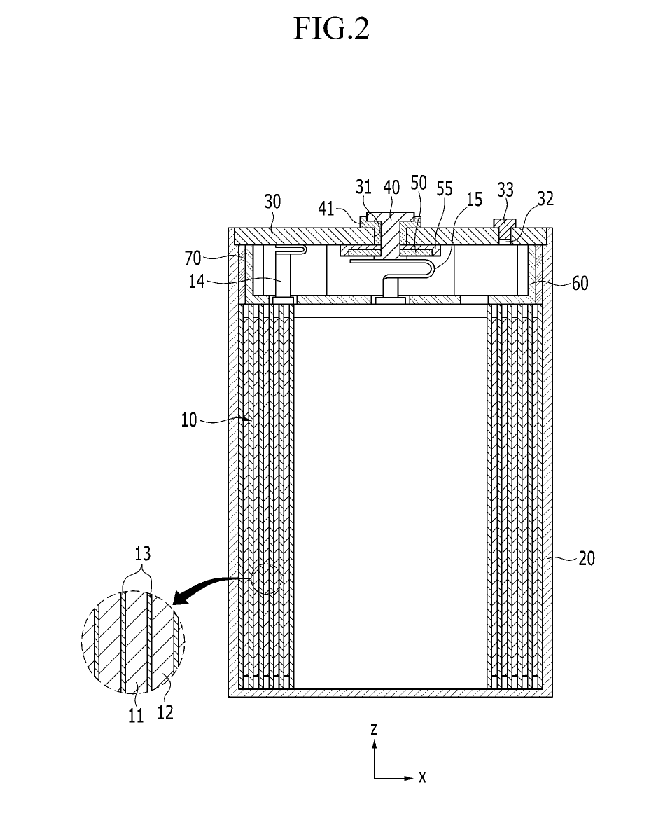

FIG. 1 is an exploded perspective view of a rechargeable battery according to one embodiment, and FIG. 2 is a cross-sectional view taken along line II-II in FIG. 1.

Referring to FIGS. 1 and 2, a rechargeable battery includes: an electrode assembly 10 performing charging and discharging; an outer case 20 containing the electrode assembly 10 together with an electrolyte; a cap plate 30 sealing an opening formed in an upper end of the outer case 20; an insulating case 60 installed between the cap plate 30 and the electrode assembly 10; and an electrode terminal 40 installed in a terminal hole 31 of the cap plate 30 and electrically connected to the electrode assembly 10. In addition, the rechargeable battery further includes a terminal plate 50 for electrically connecting the electrode terminal 40 to the electrode assembly 10.

The electrode assembly 10 has a shape corresponding to an inner space of the outer case 20 having a rectangular shape, such that the electrode assembly 10 is inserted into the outer case 20. For example, the outer case 20 includes a flat surface portion 201 corresponding to a plane of the electrode assembly 10 and a curved surface portion 202 formed at both sides of the flat surface portion 201 to correspond to a curved surface of the electrode assembly 10.

The case contains the electrode assembly 10 therein through the opening, and is formed of a conductor to function as an electrode terminal. For example, the outer case 20 may be formed of aluminum or an aluminum alloy.

The electrode assembly 10 is formed by laminating a positive electrode 11 and a negative electrode 12 on both surfaces of a separator 13 formed of an insulator, the separator 13 being interposed between the positive electrode 11 and the negative electrode 12, and then winding them in a jelly roll type. The electrode assembly 10 has a positive electrode lead tap 14 connected to the positive electrode 11 and a negative electrode lead tap 15 connected to the negative electrode 12.

The positive electrode lead tap 14 is connected to a lower surface of the cap plate by welding, and the outer case 20 is electrically connected to the positive electrode 11 of the electrode assembly 10 through the cap plate 30 to thereby function as a positive electrode terminal.

The negative electrode lead tap 15 is connected to a lower surface of a terminal plate 50 connected to one end of the electrode terminal 40 by welding, and the electrode terminal 40 provided in the terminal hole 31 of the cap plate 30 is electrically connected to the negative electrode 12 of the electrode assembly 10 to thereby function as a negative electrode terminal.

Although not shown, the negative electrode lead tap may be connected to the cap plate to allow the case to function as a negative electrode terminal, and the positive electrode lead tap may be connected to the electrode terminal to allow the electrode terminal to function as a positive electrode terminal.

The electrode terminal 40 is inserted into the terminal hole 31 of the cap plate 30 by interposing an insulating gasket 41 therebetween. That is, the insulating gasket 41 electrically insulates the terminal hole 31 and the electrode terminal from each other, and forms a sealing structure between the terminal hole 31 and the electrode terminal 40.

The terminal plate 50 is electrically connected to the electrode terminal 40 with an insulating plate 55 interposed therebetween. That is, the insulating plate 55 electrically insulates the cap plate 30 and the terminal plate 50 from each other, and further forms a sealing structure between the cap plate 30 and the terminal plate 50.

The cap plate 30 further has an electrolyte injection port 32. The electrolyte injection port 32 enables the electrolyte to be injected into the outer case 20 after the cap plate 30 is coupled with the outer case 20. After injecting the electrolyte, the electrolyte injection port 32 is sealed by a sealing stopper 33.

The insulating case 60 is installed between the electrode assembly 10 and the terminal plate 50 to electrically insulate the electrode assembly 10 and the terminal plate 50 from each other. That is, the insulating case 60 electrically insulates the positive electrode 11 of the electrode assembly 10 and the terminal plate 50 having negative polarity.

In addition, the insulating case 60 has tap holes 141 and 151 penetrating the positive electrode lead tap 14 and the negative electrode lead tap 15, respectively. Therefore, the positive electrode tap 14 may be connected to the cap plate 30 with passing through the tap hole 141, and the negative electrode lead tap 15 may be connected to the terminal plate 50 with passing through the tap hole 151.

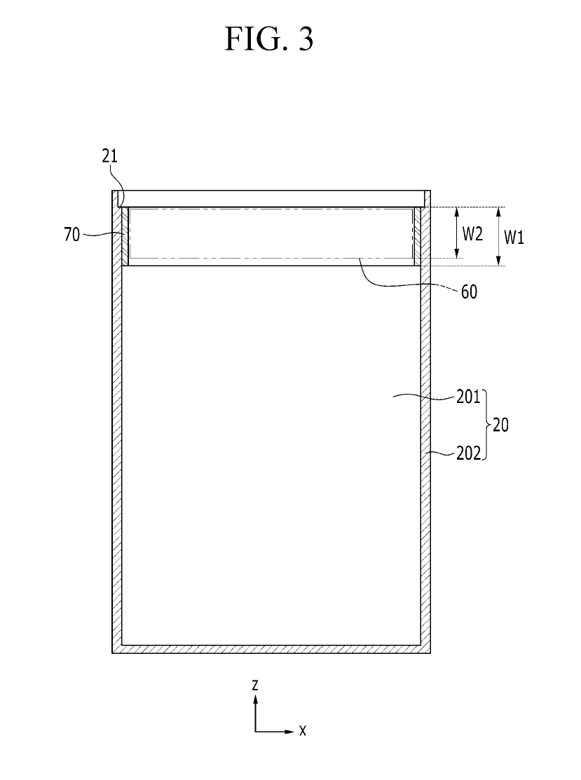

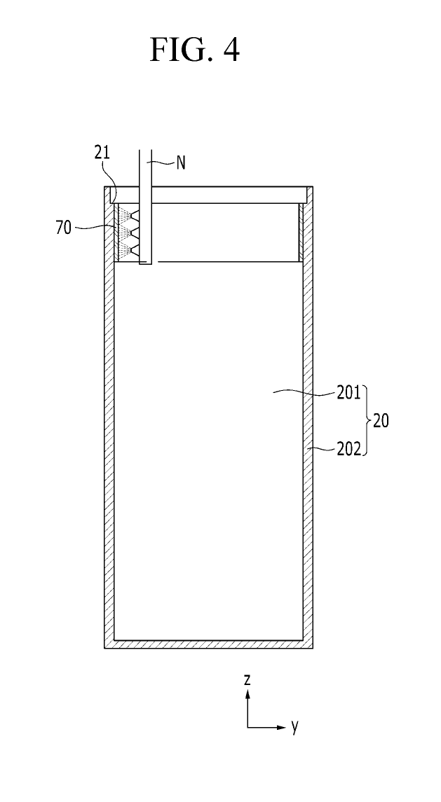

FIG. 3 is a cross-sectional view of a case taken along line II-II in FIG. 1, and FIG. 4 is a cross-sectional view of a case taken along line IV-IV in FIG. 1.

Referring to FIGS. 3 and 4, an insulating portion 70 formed of an electrical insulator is provided on an inner surface of the outer case 20, which corresponds to a space between the cap plate 30 and the electrode assembly 10. For example, the insulating portion 70 is formed of polyimide, epoxy, or polypropylene, and thus has an electrical insulating property and a property of being insoluble in an electrolyte.

In addition, as shown in FIG. 4, the insulating portion 70 may be coated on a portion of the opening of the outer case 20 by a spray method while an ink jet nozzle N is inserted into the outer case 20. Although not shown, the insulating portion 70 may be coated on the portion of the opening of the case by electro-deposition coating (not shown).

The outer case 20 has a step difference portion 21 in the opening to thereby support the cap plate 30. The step difference portion 21 temporarily fix the cap plate 30 to prevent the cap plate 30 from being excessively inserted into the outer case 20 and facilitate welding of the cap plate 30 in the opening of the outer case 20.

The insulating portion 70 has a first width (W1), which is set from the step difference portion 21 toward the electrode assembly 10 (i.e., height direction (z-axis direction)). The first width (W1) is set to be larger than a second width (W2) of the case 60.

That is, while the insulating case 60 is contacted with an inner surface of the cap plate 30, a lower end of the insulating portion 70 is lower than a lower end of the insulating case 60. Here, the electrode assembly 10 is located on a lower surface of the insulating case 60, and the an upper end of the electrode assembly 10 is located correspondingly to the insulating portion 70.

In addition, the insulating portion 70 may have a uniform thickness in a direction of the first width (W1) (z-axis direction). For example, the insulating portion 70 may have a thickness between about 8 to about 20 μm, such as, for example, 10 μm. Therefore, the insulating portion 70 may have a uniform electrical insulating property against metal foreign substances on the upper end of the electrode assembly 10 and in the opening of the outer case 20. If the thickness of the insulating portion 70 is smaller than 8 μm, the insulating structure thereof may be easily broken. If the thickness thereof is larger than 20 μm, the electrode assembly 10 may be difficult to insert.

Meanwhile, the insulating portion 70 can efficiently prevent the short circuit between the electrode assembly 10 and the outer case 20 even when the rechargeable battery is exposed to heat, and effectively cope with cell swelling due to the internal pressure of the rechargeable battery.

Hereinafter, various exemplary embodiments will be set forth. In the following exemplary embodiments, as compared with the first exemplary embodiment and the above-described exemplary embodiment, descriptions of the same elements will be omitted and descriptions of different elements will be made.

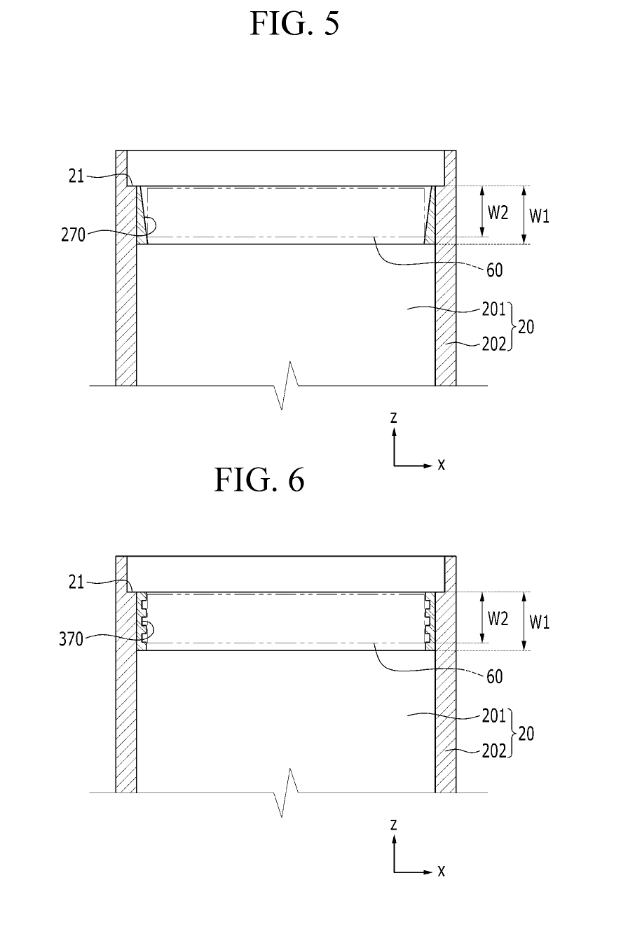

FIG. 5 is a partial cross-sectional view of a case used in a rechargeable battery according to a second exemplary embodiment. Referring to FIG. 5, in the second exemplary embodiment, an insulating portion 270 formed in the opening of the outer case 20 has an inclined structure in which an upper portion is thin and a lower portion is gradually thickened in a direction of the first width (W1) (z-axis).

Here, the inclined insulating portion 270 induces the insertion of the electrode assembly 10 through the opening of the outer case 20, and, after the insertion of the electrode assembly 10, the inclined insulating portion 270 is closely contacted with the insulating case 60. Here, a side portion of the upper end of the electrode assembly 10 is located correspondingly to the insulating portion 270.

Therefore, after the insertion of the electrode assembly 10, the insulating portion 270 can contain foreign substances flowing from the external environment in the inclined upper portion thereof, and can prevent the short circuit between the electrode assembly 10 and the outer case 20.

FIG. 6 is a partial cross-sectional view of a case used in a rechargeable battery according to a third exemplary embodiment. Referring to FIG. 6, in the third exemplary embodiment, an insulating portion 370 formed in the opening of the outer case 20 has a concave-convex structure in a direction of the first width (W1) (z-axis direction).

The insulating portion 370 having the concave-convex structure does not obstruct the insertion of the electrode assembly 10 through the opening of the outer case 20, and contains metal foreign substances flowing at the time of the insertion of the electrode assembly 10 in the concave-convex structure. After the insertion of the electrode assembly 10, the insulating portion 370 having the concave-convex structure is closely contacted with the insulating case 60. Here, a side portion of the upper end of the electrode assembly 10 is located correspondingly to the insulating portion 370.

Therefore, during and after the insertion of the electrode assembly 10, the insulating portion 370 can contain foreign substances flowing from the external environment in the concave-convex structure thereof, and prevent the short circuit between the electrode assembly 10 and the outer case 20.

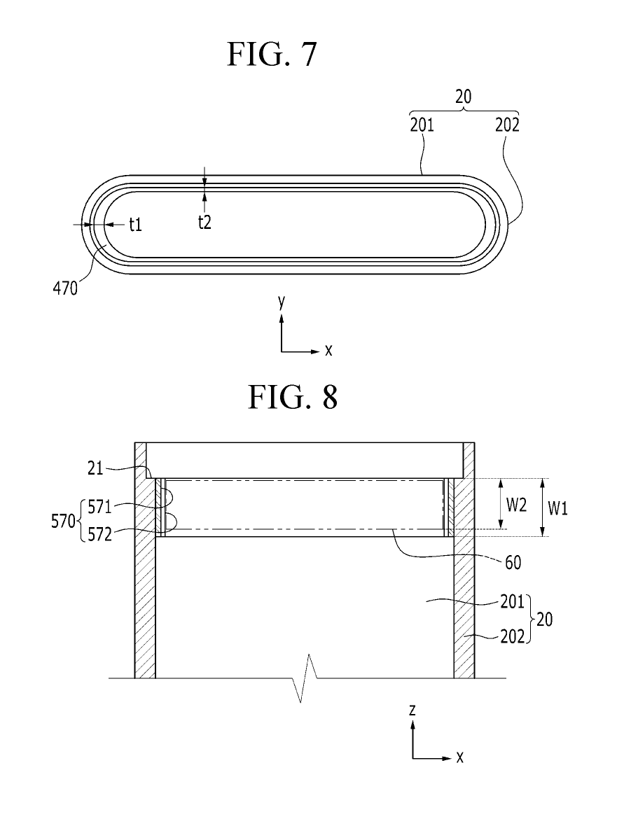

FIG. 7 is a plane view of a case used in a rechargeable battery according to a fourth exemplary embodiment. Referring to FIG. 7, in the fourth exemplary embodiment, an insulating portion 470 formed in the opening of the outer case 20 has a maximum thickness (t1) at a curved portion 202, is gradually thinner toward a flat portion, and has a minimum thickness (t2) at the flat portion, in a direction (x or y axis direction) crossing the direction of the first width (z direction).

The insulating portion 470 having a thickness-varying structure does not obstruct the insertion of the electrode assembly through the opening of the outer case 20, and rakes and contains metal foreign substances flowing at the time of the insertion of the electrode assembly 10. After the insertion of the electrode assembly 10, the insulating portion 470 having a large area is closely contacted with the insulating case 60. Here, a side portion of the upper end of the electrode assembly 10 is closely contacted with the insulating portion 470.

Therefore, during and after the insertion of the electrode assembly 10, the insulating portion 470 can contain foreign substances flowing from the external environment in the close contact structure having a large area, and prevent the short circuit between the electrode assembly 10 and the outer case 20.

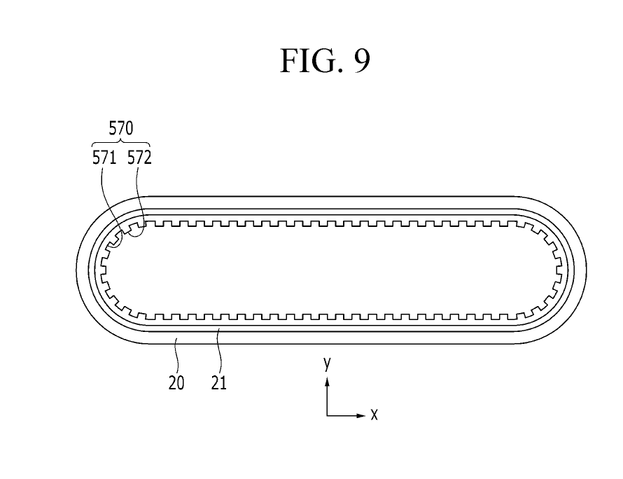

FIG. 8 is a partial cross-sectional view of a case used in a rechargeable battery according to a fifth exemplary embodiment; and FIG. 9 is a plane view of FIG. 8. Referring to FIGS. 8 and 9, in the fifth exemplary embodiment, an insulating portion 570 formed in the opening of the outer case 20 is formed in a direction of the first width (z axis direction), and includes grooves 571 and protrusions 572 alternately arranged along a direction (x or y axis direction) crossing the direction of the first width.

The insulating portion 570 having grooves 571 and protrusions 572 does not obstruct the insertion of the electrode assembly 10 through the opening of the outer case 20, and contains metal foreign substances flowing at the time of the insertion of the electrode assembly 10. After the insertion of the electrode assembly 10, the insulating portion 570 having grooves 571 and protrusions 572 is closely contacted with the insulating case 60. Here, a side portion of the upper end of the electrode assembly 10 is closely contacted with the protrusions 572 of the insulating portion 570.

Therefore, during and after the insertion of the electrode assembly 10, the insulating portion 570 can contain foreign substances flowing from the external environment in the grooves 571 between protrusions 572, and prevent the short circuit between the electrode assembly 10 and the outer case 20.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A rechargeable battery including:
an electrode assembly;
an outer case configured to enclose the electrode assembly, wherein the outer case includes an opening;
a cap plate configured to seal the opening of the outer case;
an insulating case of a predetermined height installed within the outer case, the insulating case installed between the cap plate and the electrode assembly; and
an electrode terminal installed on the cap plate and electrically connected to the electrode assembly,
wherein the outer case includes an insulating portion formed on an inner surface of the opening thereof adjacent said insulating case, said insulating portion being electrically insulating, and said insulating portion located at an upper portion of the outer case and being shaped to prevent foreign substances from flowing from the external environment into the outer case.

2. The rechargeable battery of claim 1, further comprising an electrolyte, wherein the outer case is configured to enclose the electrolyte; and the insulating portion is insoluble in the electrolyte.

3. The rechargeable battery of claim 1, wherein the insulating case is formed with a step difference from the opening of the outer case.

4. The rechargeable battery of claim 1, wherein the insulating portion has a first height between the opening and the electrode assembly, wherein the first height is larger than the predetermined height of the insulating case.

5. The rechargeable battery of claim 1, wherein a lower surface of the insulating portion is closer to the electrode assembly than a lower surface of the insulating case.

6. The rechargeable battery of claim 1, wherein the insulating portion comprises at least one of polyimide, epoxy, or polypropylene.

7. The rechargeable battery of claim 1, wherein the insulating portion has a uniform thickness along its height.

8. The rechargeable battery of claim 1, wherein the insulating portion has an inclined structure along its height, wherein the insulating portion is gradually thickened in a direction from the opening to the electrode assembly.

9. The rechargeable battery of claim 1, wherein the insulating portion has a concave-convex structure along its height.

10. The rechargeable battery of claim 1, wherein the outer case includes two flat surface portions and two curved portions surrounding the flat surface portions, and wherein the insulating portion has a maximum thickness in a direction between the outer case and the insulating case.

11. The rechargeable battery of claim 1, wherein the insulating portion comprises a plurality of grooves and protrusions alternately arranged between the insulating case and the outer case.

12. The rechargeable battery of claim 1, wherein the insulating portion surrounds the insulating case.

13. The rechargeable battery of claim 1, wherein the thickness of the insulating portion is from about 8 to about 20 micrometers.

14. A method of producing a rechargeable battery, the method including:
providing an electrode assembly;
forming an insulating portion on an upper portion of an inner surface of an outer case, wherein the outer case includes an opening above the upper portion;
enclosing the electrode assembly in the outer case;
installing an insulating case of a predetermined height within the outer case, whereby the insulating case is adjacent the insulating portion;
sealing the opening of the case with the cap plate, whereby the insulating case is between the cap plate and the electrode assembly;
installing an electrode terminal on the cap plate, said electrode terminal being electrically connected to the electrode assembly.

15. The method of claim 14, wherein forming the insulating portion includes spray coating using an ink jet nozzle.

16. The method of claim 14, wherein forming the insulating portion includes electro-deposition coating.

17. The method of claim 14, further comprising injecting an electrolyte through an electrolyte injection port in the cap plate.

18. The method of claim 14, wherein the thickness of the insulating portion formed is from about 8 to about 20 micrometers.
